(19) United States
(12) Patent Application Publication
(10) Pub. No.: US 2005/0264650 A1
(43) Pub. Date: Dec. 1, 2005

(54) Apparatus and method for synthesizing captured images in a mobile terminal with a camera

(75) Inventors: Jung-Hoon Park, Suwon-si (KR); Jae-Hoon Kwon, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/138,419

(22) Filed: May 27, 2005

(30) Foreign Application Priority Data
May 28, 2004 (KR) 2004-38549

(51) Int. Cl. H04N 7/18

(52) U.S. Cl. 348/36

(57) ABSTRACT

An apparatus and method for synthesizing images captured by a mobile terminal with a camera to generate a panorama image. A first memory stores a first captured image in panorama mode for synthesizing captured images. A second memory stores captured images subsequent to the first captured image. The images stored in the first and second memories are compared and synthesized. When a difference value between the compared images is less than a threshold value, a synthesized image is stored in the first memory.

### PRIORITY

This application claims the benefit under 35 U.S.C. § 119(a) of an application entitled “Apparatus and Method for Synthesizing Captured Images in a Mobile Terminal with a Camera” filed in the Korean Intellectual Property Office on May 28, 2004 and assigned Serial No. 2004-38549, the entire contents of which are incorporated herein by reference.

### BACKGROUND OF THE INVENTION

1. Field of the Invention

The present invention generally relates to an apparatus and method for providing a user service in a mobile terminal. More particularly, the present invention relates to an apparatus and method for synthesizing images captured by a mobile terminal with a camera to generate a panorama image.

2. Description of the Related Art

Mobile terminals were initially developed to provide voice communication. With the development of technology, mobile terminals have developed into devices capable of providing users with various services. Accordingly, mobile terminals can provide various data services for text messages, still or moving images, and mobile banking. A user can capture various images through a mobile terminal with a camera, and can transmit the captured images. More specifically, the captured images are used in a background screen or photo mail without being modified, and are edited and used through an image edit program of a personal computer. The camera can use a charge coupled device (CCD) or complementary metal oxide semiconductor (CMOS) sensor. A display unit of the mobile terminal can use a liquid crystal display (LCD). The mobile terminal can capture moving and still images through the camera, and can display the captured images on the LCD. Moreover, the mobile terminal can send the captured images to a base station.

To generate a panorama image larger than a general image through the camera mounted in the mobile terminal, a personal computer is used. Because the camera mounted in the mobile terminal is smaller than a conventional digital camera, close-up or zoom capability and image sharpness associated with the camera mounted in the mobile terminal are low. There is a problem in that the pixel ratio of legible letters is low when the camera mounted in the mobile terminal captures an image of a document.

### SUMMARY OF THE INVENTION

It is, therefore, an aspect of the present invention to provide a method and apparatus for synthesizing images captured by a camera mounted in a mobile terminal.

It is another aspect of the present invention to provide a method and apparatus for comparing a first image with a subsequent image, searching for duplicate parts from the images, and synthesizing the images in a mobile terminal with a camera.

The above and other aspects of the present invention can be achieved by a method for synthesizing images captured by a mobile terminal with a camera. The method comprises the steps of storing a first image in a first memory; storing a subsequent image in a second memory; and comparing the images stored in the first and second memories, searching for duplicate parts from the images, and combining the images.

The above and other aspects of the present invention can also be achieved by a mobile terminal with a camera. The mobile terminal comprises first and second memories; and a device for comparing images stored in the first and second memories, synthesizing the images when a difference between boundary values of the images is less than a threshold value, and storing a result of synthesizing the images in the first memory.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a structure of a mobile terminal in accordance with an embodiment of the present invention;

FIG. 2 is a flow chart illustrating a process for synthesizing images in a panorama mode in the mobile terminal in accordance with an embodiment of the present invention;

FIG. 3A illustrates a process for searching for duplicate parts by comparing an image stored in a first memory with an image stored in a second memory in accordance with an embodiment of the present invention;

FIG. 3B illustrates a synthesized image obtained by synthesizing the images stored in the first and second memories while taking into account the duplicate parts in accordance with an embodiment of the present invention; and

FIG. 4 illustrates a process for comparing at least three successive images, searching for duplicate parts, and synthesizing the images in accordance with an embodiment of the present invention.

Throughout the drawings, the same or similar elements are denoted by the same reference numerals.

### DETAILED DESCRIPTION OF EXEMPLARY EMBODIMENTS

Embodiments of the present invention will be described in detail herein below with reference to the accompanying drawings.

In the following description made in conjunction with embodiments of the present invention, a variety of specific elements are shown. The description of such elements are exemplary. Additionally, in the following description, a detailed description of known functions and configurations incorporated herein will be omitted for conciseness.

An image capture method in accordance with an embodiment of the present invention can be applied to a digital camera and any device with a camera function. In accordance with an embodiment of the present invention, an example of a mobile terminal with a camera will be described. However, the present invention is not limited to a mobile terminal with a camera, but can be applied to any device that can capture an image and can be equipped with a microprocessor of relatively small processing capacity.

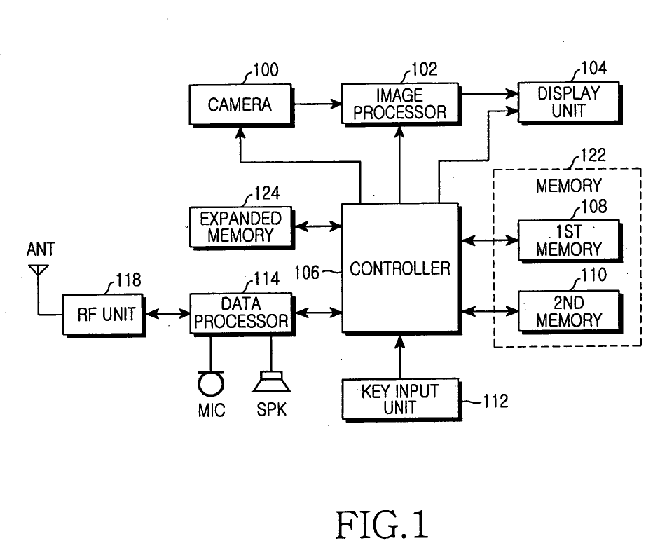

FIG. 1 is a block diagram illustrating a structure of a mobile terminal in accordance with an embodiment of the present invention.

Referring to FIG. 1, a radio frequency (RF) unit 118 comprises an RF transmitter (not illustrated) for up converting and amplifying a frequency of a signal to be transmitted, and an RF receiver (not illustrated) for low-noise amplifying a received signal and down converting a frequency of the received signal. A data processor 114 comprises a transmitter (not illustrated) for encoding and modulating the signal to be transmitted and a receiver (not illustrated) for demodulating and decoding the received signal. That is, the data processor 114 can comprise a modulator-demodulator (MODEM) and a coder-decoder (CODEC). Here, the CODEC comprises a data CODEC for processing packet data, and the like and an audio CODEC for processing an audio signal such as voice, and the like. The data processor 114 performs a function for reproducing a received audio signal output from the audio CODEC or outputting a transmission audio signal generated from a microphone to the audio CODEC. More specifically, the data processor 114 can be implemented such that an image recapture request can be sent to a user using an audible indication such as a beeping sound or the like via a speaker when no duplicate image part is identified in a process for comparing and synthesizing images. Moreover, the data processor 114 receives and processes voice for guidance information and an operation result from a controller 106.

A key input unit 112 comprises keys necessary for inputting number and letter information and function keys necessary for setting various functions. More specifically, the key input unit 112 can comprise function keys for controlling an image mode and an image capture key for operating a camera 100 in accordance with an embodiment of the present invention.

A memory 122 of the mobile terminal can comprise a read only memory (ROM) and a random access memory (RAM). The memory 122 can store a program for controlling the overall operation of the mobile terminal, and a program for controlling a path of an image signal to be applied to a display unit 104 in accordance with an embodiment of the present invention. The memory 122 can temporarily store data generated from a processing operation, and can store user data comprising phone numbers, ring tones, image information, and the like.

As illustrated in FIG. 1, the memory 122 is divided into a first memory 108 and a second memory 110 such that the present invention can be better understood. The memory 122 may also comprise a single memory device comprising the first and second memories 108 and 110.

In accordance with an embodiment of the present invention, the first memory 108 is used to store a first image and the second memory 110 is used to store subsequent images such that the images can be compared. The first memory 108 stores the first image, and the second memory 110 stores the next images subsequent to the first image. In addition to the memory 122, an external expanded memory 124 such as a memory card is provided.

The controller 106 controls the overall operation of the mobile terminal, and generates and stores a synthesized image signal in response to a mode command set through the key input unit 112 in accordance with an embodiment of the present invention. More specifically, the controller 106 controls an operation for transmitting and receiving the synthesized image signal. The controller 106 performs a function for outputting, to the display unit 104, specific state information associated with a text message arrival state, a dialing state, and an avatar setup state, and data received from the camera 100. Additionally, the controller 106 controls the display unit 104 to display a current time, reception sensitivity, a remaining amount of battery power, and so on.

The camera 100 comprises a camera sensor (not illustrated) for converting an optical signal into an electrical signal when an image is captured, and a signal processor (not illustrated) for converting an analog image signal captured by the camera sensor into digital data. The camera sensor may be implemented by a charge coupled device (CCD) sensor, and the signal processor may be implemented by a digital signal processor (DSP) or others. The camera sensor and the signal processor may be integrated in a single body, or may be separate stand-alone units.

An image processor 102 generates display data for displaying an image signal output from the camera 100. The image processor 102 processes the image signal output from the camera 100 in frame units. The image processor 102 outputs the frame image data appropriate to the characteristics and size of the display unit 104.

The display unit 104 displays a frame image signal output from the image processor 102 on a screen, and displays user data output from the controller 106. The display unit 104 displays the image signal according to a control operation of the controller 106. The display unit 104 can comprise a liquid crystal display (LCD). The display unit can comprise a LCD controller, a memory capable of storing image data, a LCD element, and others. When the LCD is implemented using a touch-screen system, the LCD can serve as an input unit.

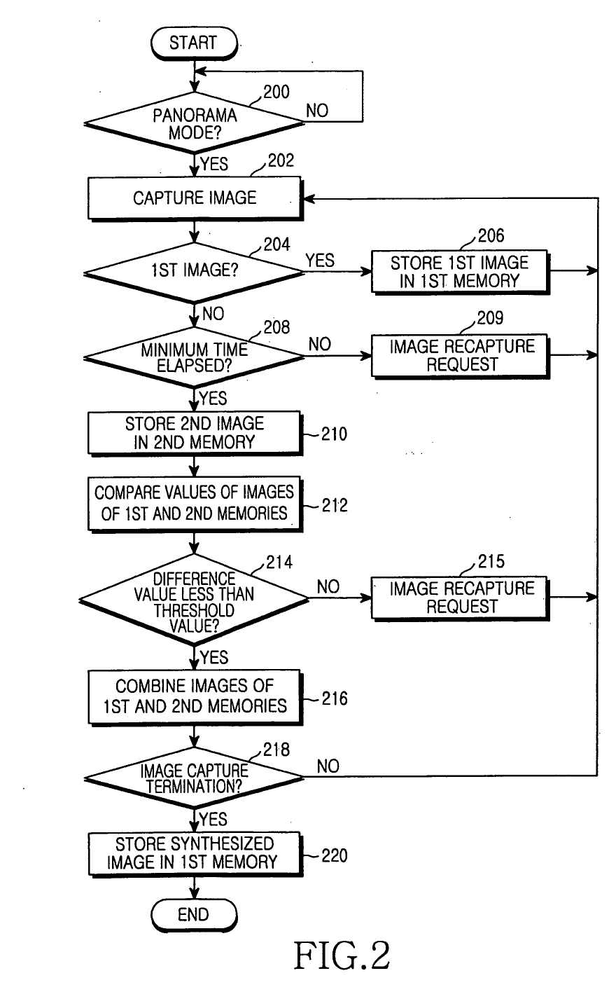

FIG. 2 is a flow chart illustrating a process for synthesizing images in a panorama mode in the mobile terminal in accordance with an embodiment of the present invention. The embodiment of the present invention will be described with reference to FIG. 2.

Before the process of FIG. 2 is performed, the mobile terminal must enter a camera image capture mode after the user applies a predetermined signal through the key input unit 112, and an image capture direction must be designated from among up, down, left, and right directions keys. When an image output from the camera 100 is displayed on the LCD through the image processor 102 according to a control operation of the controller 106, it is referred to as a preview mode. When an image capture request is not present, the controller 106 continuously operates in the preview mode according to the operation of the camera 100 such that the user can view an image output from the camera 100. The image capture method can capture an image after operating the camera 100 to perform the preview mode, and can capture an image simultaneously when the camera 100 operates. When the user operates the camera 100 to capture an image of a specific object or scene, the image processor 102 operates in the preview mode, and then the display unit 104 displays the image output through the camera 100. In step 200, the user determines whether to capture an image in the panorama mode through the key input unit 112. When the panorama mode is selected in step 200, the process proceeds to step 202. In step 202, the controller 106 controls the camera 100 to capture an image. In this case, the image processor 102 outputs the captured image to the display unit 104. The display unit 104 displays the image on a display window. The user determines whether to capture an image in a vertical or horizontal direction, and captures an image at a suitable speed in the vertical or horizontal direction while being on the move.

In step 204, the controller 106 determines if an image captured by the camera 100 is a first image. If the captured image is the first image, the controller 106 stores the first image in the first memory 108 in step 206. After the first image is stored in the first memory 108, the controller 106 controls the camera 100 to capture the next image in step 202. However, if the captured image is not the first image, the controller 106 determines if the minimum time interval between the first image stored in the first memory 108 and the next image has elapsed in step 208. If the minimum time interval has elapsed, the controller 106 stores the second image in the second memory 110 in step 210. However, if the minimum time interval has not elapsed, the controller 106 sends an image recapture request message to the user through the speaker coupled to the data processor 114 or the display unit 104 in step 209, and controls the camera 100 to recapture an image in step 202.

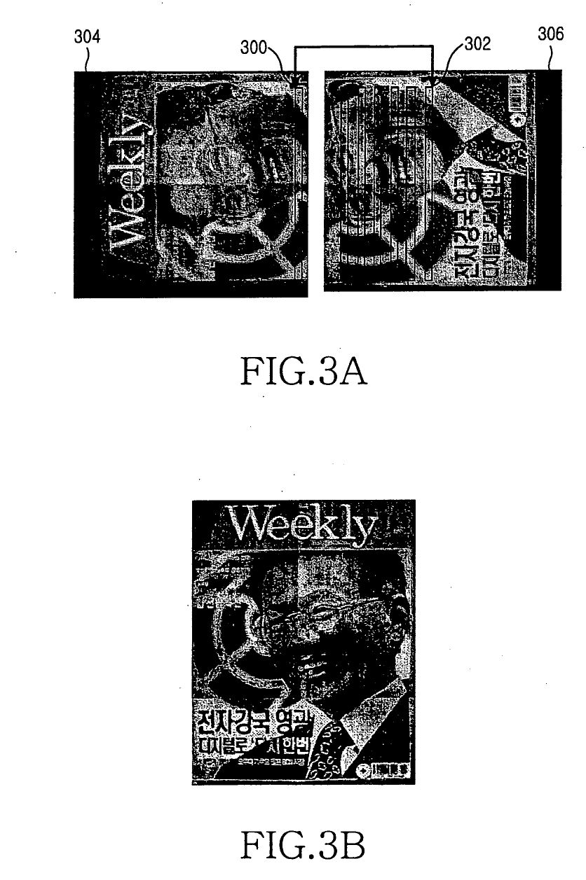

In step 212, the images stored in the first and second memories 108 and 110 are compared. An operation for comparing values of the images stored in the first and second memories 108 and 110 will be described in more detail with reference to FIGS. 3A and 3B. In step 214, the controller 106 determines if a difference between color values of specific parts of the two images is less than a threshold value after comparing the values of the two images. If the difference between the color values is less than the threshold value, the controller 106 determines that the two images include duplicate parts, and synthesizes the two images in step 216. However, if the difference between the color values is greater than or equal to the threshold value, the controller 106 sends an image recapture request message to the user in step 215. When the user selects the image capture termination through the key input unit 112 after the two images are synthesized in step 218, the controller 106 stores a synthesized image in the memory 108 in step 220.

FIG. 3A illustrates a process for searching for duplicate parts by comparing an image stored in the first memory 108 with an image stored in the second memory 110 in accordance with an embodiment of the present invention. A process for combining the images stored in the first and second memories 108 and 110 will be described in more detail with reference to FIG. 3A. For convenience of explanation, an example of combining only two successive still images will be described. Those skilled in the art will appreciate that the ability of combining images may be defined by the size or characteristics of the memory 122.

FIG. 3A illustrates two images captured from one document sheet. The captured images comprise duplicate parts or portions. The two images are captured as illustrated in FIG. 3A because a focusing distance of the camera mounted in the mobile terminal is shorter than that of the conventional digital camera. When the camera is close to the document sheet, it is difficult for the whole image to be obtained. In FIG. 3A, a color value of the uttermost right boundary of the left (first) image 304 is compared with that of the right (second) image 306. The controller 106 compares the first image 304 with the second image 306 in a pixel unit in a horizontal direction. After the left image 304 of FIG. 3A is stored in the first memory 108, the color value of the uttermost right boundary of the left image 304 is stored in the first memory 108. When a pixel value stored in the first memory 108 is compared with that stored in the second memory 110, a margin of about 10% of the total image width is set because the camera may be shifted vertically when the user captures the images. An algorithm for comparing color values of the two images 304 and 306 uses a well-known method for comparing red, green, and blue (RGB) values of pixels. Specifically, the pixels are compared using discrete cosine transform (DCT). When the two images are compared, it is determined that duplicate parts are present if a difference between pixel values of the two images is less than a threshold value. Then, the two images are synthesized. The threshold value is a value obtained through a test of a manufacturer of a mobile terminal with a camera, and is set to compensate for an image difference due to a change of an amount of light, camera shake, or others when images of the same object or scene are captured. When the user selects the image capture termination through the key input unit 112 after the synthesizing process is completed, a synthesized image (illustrated in FIG. 3B) is stored in the first memory 108 according to a control operation of the controller 106.

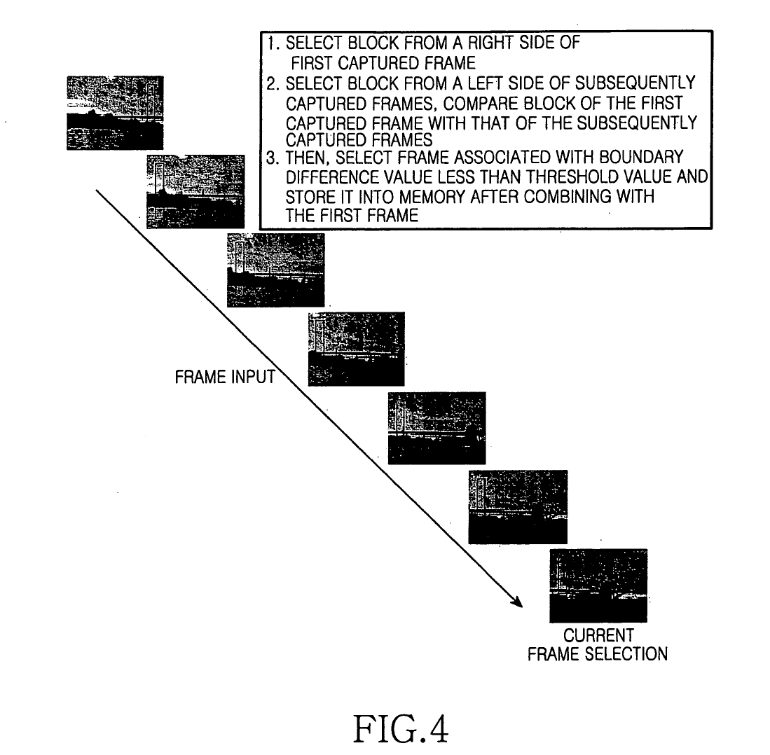

FIG. 4 illustrates a process for comparing at least three successive images, searching for duplicate parts, and synthesizing the images in accordance with an embodiment of the present invention. FIG. 4 illustrates a process for successively capturing seven images of a scene from left to right through the camera 100, and synthesizing the captured images in the mobile terminal in accordance with an embodiment of the present invention.

In FIG. 4, the controller 106 selects a block to have a size of one pixel from a right side of the first captured image to a horizontal direction and a size of 80% of the vertical direction of a corresponding frame in the vertical direction. The controller 106 selects a block to have a size of one pixel from a left side of each of subsequently captured images to a horizontal direction and a size of 80% of the vertical direction of a corresponding frame in the vertical direction. Then, the block of the first image is compared with respective block of the subsequently captured images. As a result of the comparison, the images associated with a boundary difference value less than a threshold value are selected and synthesized with the first image. Then, when the user inputs a termination signal through the key input unit 112, a synthesized image is stored in the first memory 108.

As is apparent from the above description, the present invention provides a method for generating a panorama image by synthesizing images output from a camera mounted in a mobile terminal. The present invention can solve a problem that a user must synthesize captured images while viewing an object or scene. In accordance with the present invention, the mobile terminal with the camera can generate a synthesized image of the user's desired size without using a complex program after capturing images, and can transmit the synthesized image as in a facsimile.

While the invention has been shown and described with reference to certain embodiments thereof, it will be understood by those skilled in the art that various changes in form and details may be made therein without departing from the spirit and scope of the invention as defined by the appended claims.

1. A method for synthesizing images captured by a mobile terminal with a camera, comprising:
determining if a predetermined time interval between a capturing timing of the image and a capturing timing of a previously stored image is elapsed;
comparing boundary values of the images and examining a difference between the boundary values if the predetermined time is elapsed;
combining the images such that the images are superimposed; and
storing the superimposed image.

2. The method of claim 1, wherein the step of capturing is repeated until a user request a termination of capturing images.

3. The method of claim 1, further comprising the step of:
receiving a direction of capturing from a user.

4. The method of claim 3, wherein the boundary is determined according to the direction.

5. The method of claim 1, wherein the boundary value comprises at least one RGB value per unit pixel.

6. An apparatus for synthesizing images captured by a mobile terminal with a camera, comprising the steps of:
a controller for determining if a predetermined time interval between a capturing timing of a image and a capturing timing of a previously stored image is elapsed, and comparing boundary values of the images and examining a difference between the boundary values if the predetermined time is elapsed, and combining the images such that the images are superimposed, and storing the superimposed image;
a first memory for storing the captured image; and
a second memory for storing the superimposed image.

7. The apparatus of claim 6, further comprising:
a key pad for receiving a termination request of capturing images from a user.

8. The apparatus of claim 7, wherein the capturing images is repeated until the termination request is received.

9. The apparatus of claim 6, further comprising:
a key pad for receiving a direction of capturing from a user.

10. The apparatus of claim 9, wherein the boundary is determined according to the direction.

11. The apparatus of claim 6, wherein the boundary value comprises at least one RGB value per unit pixel.
